(19) United States
(12) Patent Application Publication
(10) Pub. No.: US 2003/0052862 A1
(43) Pub. Date: Mar. 20, 2003

(54) Finger tip pointer control

(75) Inventor: Edward F. Larkin, Winthrop, ME (US)

Correspondence Address: STANLEY R. JONES, PATENTS, 49 MIDDLE STREET, HALLOWELL, ME, 04347, US

(73) Assignee: The Mouse Bungee Company

(21) Appl. No.: 09/955,252

(22) Filed: Sep. 19, 2001

(51) Int. Cl. G09G 5/08

(52) U.S. Cl. 345/163

(57) ABSTRACT

A manually moveable control unit for moving a pointer on a console display screen, which unit has a manually moveable base with a forward end being of substantially triangular shape joined with a semicircular rear end of a first diameter and a disk-like fingertip dial extending upward from the rear end of said unit also in substantially semicircular shape of a second smaller diameter and fingertip holding means which includes soft pliable gripping surfaces housed in each of said semicircular ends of the control unit.

### FIELD OF THE INVENTION

The field of the present invention relates to screens including a manually controlled pointer/cursor and finger tip control for same. Further, the field of this pointer control invention relates to one that has two different sizes and levels of manually moveable rearward dials for improved scope, speed and accuracy in moving a pointer on a screen.

Further, the field of this invention relates to an optic “mouse” or pointer control for computer uses. Additionally, this invention relates to the field of ergonomics for improved manually controlled devices that do not require arm movement for manually achieving improved pointer control on computer screens and similar devices.

### EXPLANATION OF TERMS

My invention interfaces and operates in conjunction with display screens as found primarily on computer consoles. Provided below are brief descriptions of certain relevant terms which further the understanding of the invention and provide a basis for a detailed teaching of the improvement in the art provided by this invention.

### POINTER CONTROL

Computer screens include a visual pointer for user selection purposes from a computer-displayed menu, or for word processing and editing purposes and the like. Control of the visual pointer on such a screen is achieved by user-initiated movement of a so-called “mouse” or hand moveable pointer control. For decades such control has been achieved by a mouse guided by the palm of a user together with the user's arm and hand movements

### CENTER OF MOVEMENT

Most pointer controls have a movement tracker that is centrally located under the palm of the user and this tracker mechanically moves as the user moves his hand and arm for pointer control. For example, in a rubber ball mouse, the tracker ball is centrally housed at about the middle of the mouse and a lower section of the ball projects below the housing for contact with a desk surface. Movement of the mouse rolls the ball and that mechanical rotation, in turn, is converted electrically into positioning information that can be sent by wire (or perhaps by wireless) to a computer in order to move the pointer on a display screen for the computer.

### OPTICAL SENSOR

Recent developments have brought forth an optical sensor, camera and computer chip which are housed in a manual pointer control in order to supply scanning, sensing and position tracking information to the computer. Such information is transmitted to software in a computer for pointer control. Movement of the optical sensor and its associated scanning electronics requires hand-to-eye coordinated movements of a manual pointer control device.

### FORWARD END

An optical sensor is located as a tracker in the extreme forward end of a manual pointer control that has a substantially triangular shape.

### REARWARD END

Two semicircular curved shapes are formed in the rear of a base for said control unit. The second semicircular shape is disk-like having a slanted front which is fitted with switches, while the rearward section of the control device is adapted with a gripping surface for fingertip movements.

### CONTROL BUTTONS

One, two or three buttons, or switches, are housed in a pointer control. Depressing such buttons toggles micro switches as necessary for menu selection and other computer operations. Such switches in the prior art controls are generally mounted on the front end of a mouse. In this invention, however, such switches or buttons are mounted rearwardly of the center of movement for the control.

### BACKGROUND OF THE INVENTION

Desk space it seems is always at a premium. The pad and mouse location for computer control must be left clear and that clearing is wasted space as far as the desk surface is concerned. A smaller and more efficient pointer control is a benefit as far as desk space is concerned. Moreover left and right handed people both must be accommodated for, and this accommodation increases the amount of so-called “wasted” desk space.

The computer games of today are the rage, and such games require extreme speed in up-down and left-right cursor movements on a computer screen. Since the computer user is actually playing a game against computer software, the pointer on the computer screen must be moved with skillful eye-to-hand coordination for a user to win. Such computer game playing demands precise control skill, swift and accurate movement and positive depression of control buttons on the manually moveable pointer control.

There are some health risks associated with computer use. For example, Carpal Tunnel Syndrome (“CTS”), sometimes referred to as Repetitive Motion Injury (“RMI”), is usually caused by continuously repeating the same motion with hand, wrist and arm. CTS/RMI results when pressure is developed on the median nerve, which nerve is located in the wrist's “carpal tunnel” formed by carpal bones and a transverse carpal ligament. Such pressure can cause swelling and ultimately pinched and painful throbbing, tingling or numbness in the hand and fingers. Extended periods of computer game playing and word processing with a conventional mouse/pointer control may cause such CTS/RMI injuries.

Additionally, as one uses a centrally located ball or optic sensor mouse one notes that often the mouse control is lifted and moved for initial pointer placement on the screen. This involves movement of both the hand and the arm. These are precisely the types of movements which can and do cause CTS/RMI. Furthermore, lifting the control requires time and energy that could be more beneficially spent on compact and precise pointer control. Fingertip control, as provided by this invention, obviates many of these drawbacks of the prior art.

### DESCRIPTION OF PRIOR ART

Turning now to the prior art, a conventional mouse with a centrally located tracking 12 is shown in the prior art of FIG. 1. FIG. 1 includes FIGS. 1A, 1B, and 1C which are respectively a side, top and block diagram view of a prior art mouse that has been in use during the last two decades. While symbolic, one will recognize that the side view (FIG. 1A) and top views (FIGS. 1B and 1C) are representative of a Microsoft mouse 10 that has a central wheel 15 and two forwardly-located switches 16 and 18.

In the prior art, these two switches 16 and 18 are one each located on the right and left hand sides respectively of the forwardly located middle wheel 15. Depressing any of these switch areas 16, 18 including depressing the centrally mounted wheel 15—will close one or more of the switches shown in block diagram in FIG. 1C.

Perhaps as best shown in FIGS. 1A and 1B, of the prior art mouse, the convex shape of the device is appropriately fitted for the palm of either a right or left handed user. As symbolically shown in prior art FIGS. 1A and 2, these are palm controlled devices with a center tracking function. In FIG. 1A, both a rubber ball and/or an optical sensor is shown within the tracking box 12 although only one or the other—not both—would normally be used.

Being a palm controlled device, the prior art mouse 10 involves manual movement in all three motions—X (right or left pointer control) Y (up and down pointer movement) and Z, with Z being the mostly unconscious lifting of the mouse for initial or pointer re positioning. Thus, the arm, hand and wrist are all normally involved in controlling the tracking movement of the prior art mouse. Indeed, one discovers lifting of the mouse and repositioning it on the desk pad in order to get a corresponding cursor tracking position on the console screen is prevalent and wastes considerable motion.

Also located at the forward end of the mouse 10 is a cord 11 for connecting the mouse tracking and switching functions to the computer per se. Such cords deliver and receive signals between the control and the computer, and are generally compatible with USB and PS/2 computer terminals. More recently, a wireless mouse has been announced, which mouse includes batteries and radio transmission of signals representative of the switching and tracking functions between control and computer.

In view 1B (a top view looking down) switching includes wheel selection switching as normally done by depressing wheel 15 and/or depressing a left and a right hand switch 16, 17. These switching controls are shown in the block diagram simply as B1, B2 and a wheel B3. I have discovered that such prior art, tracking and switching has been a stumbling block in the way of an improvement that has been badly needed for the last two decades.

The advantages and inventive nature of my apparatus and method over the aforementioned prior art is significantly two fold. First, a user can more efficiently and accurately control pointer movement by a forwardly located optical tracking sensor and an ergonomically-shaped rearwardly located two level fingertip dial control. Improved pointer control is achieved by two rearward dial levels having a smaller and a larger dial diameter. Such dials are provided with peripheral grip surfaces for more positive control.

Thus, my apparatus and method physically relocates switching and tracking functions and provides fingertip, rather than palm, control for a highly improved and novel pointer control for a computer.

### SUMMARY OF THE INVENTION

The pointer control of this invention, in short summary, has moved a prior art tracking function normally located at the middle of the mouse to the extreme forward end of a novel fingertip moveable pointer control for computers. Switching, while still provided by standard wheel and a pair of left right buttons, has moved slightly to the rear of the center of the control, ie. where the tracking control was previously located. Two different diameter and different level finger dials of unique shape including peripherally-located gripping surfaces are positioned at the rear of a smaller and more efficient pointer control. Superior fingertip control has replaced the palm control of the prior art.

In the prior art, mouse twisting or mouse rotation—due to the center tracking location—did nothing other than cause erratic screen activity without achieving any worthwhile result. My pointer control with its extreme forward tracking function via an optical sensor in conjunction with contoured rear curvature provides quick and accurate right-to-left fingertip movements around a center of rotation for the “mouse”. Thus a distinct drawback of the prior art has not only been eliminated but has been replaced by additional flexibility of control in this invention.

Additionally, fingertip control allows movement forward and back for up and down screen pointer control by simply curling and straightening the thumb and middle fingers thus eliminating excessive wrist, hand and arm movement that characterized the prior art. In the computer, sensitivity is provided such that the amount of left right movement can fill the screen. Likewise, up and down sensitivity can be adjusted for full screen pointer movement for a smaller amount of movement on the desk surface.

### OBJECTS OF THE INVENTION

It is an object to provide a pointer control for a computer screen that has a tracking function in the form of an optical tracking sensor at the forward end of the manually moveable pointer control device.

It is yet one additional object to eliminate mid-mouse tracking and replace that function by locating switching functions slightly to the rear of the middle of the mouse.

It is an object to provide buttons for right-to-left and up-and-down screen pointer control by a manually moveable control device of a novel shape that allows fingertip controls at the rear of the control.

It is another object to provide a mouse having at the rearward section thereof two different levels and two different diameter fingertip dials for improved control over a computer pointer.

It is a further object to replace a user's palm control of a mouse by fingertip controls for improved speed, accuracy and sensitivity without excessive arm movement that characterizes the prior art.

It is an object to provide a method and apparatus with an additional dimension of pointer control by fingertip rotation of the control about the center of movement of the mouse.

It is a further object to develop a new dimension of movement in place of a rotation movement of the prior art that caused only erratic screen activity.

### BRIEF DESCRIPTION OF THE DRAWING

FIG. 1, includes FIGS. 1A, 1B and 1C which respectively are a side, top and block diagram of a standard prior art mouse;

FIG. 2 is another prior art view showing palm control of a mouse;

FIG. 3 is a perspective view of the new pointer control of the invention;

FIG. 4, includes FIGS. 4A, 4B and 4C which respectively are a side, top and block diagram of the invention; and

FIG. 5 is a top view showing fingertip movement for left to right pointer control in accordance with this invention.

### DESCRIPTION OF EMBODIMENT(S)

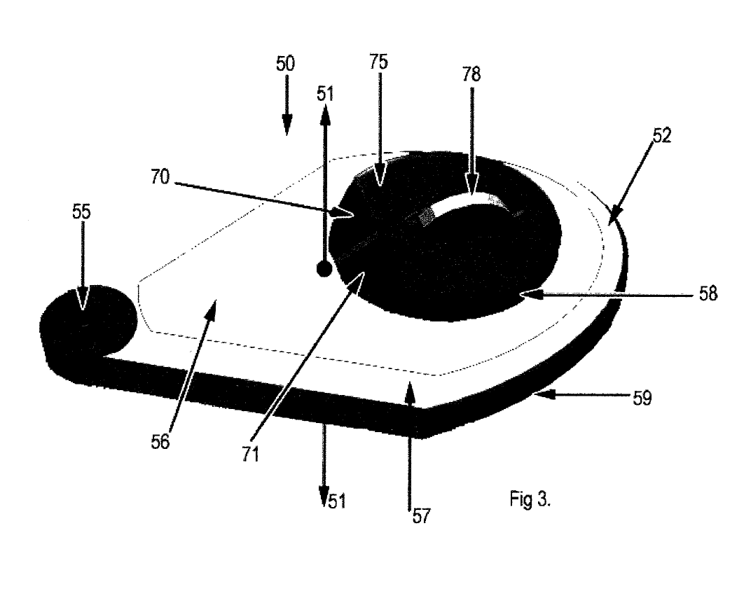

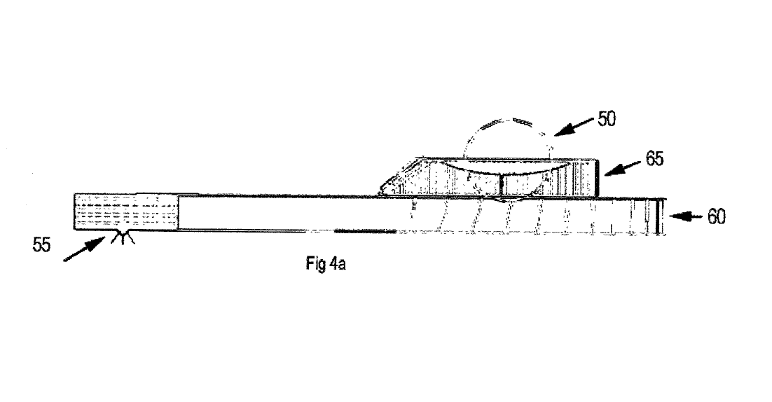

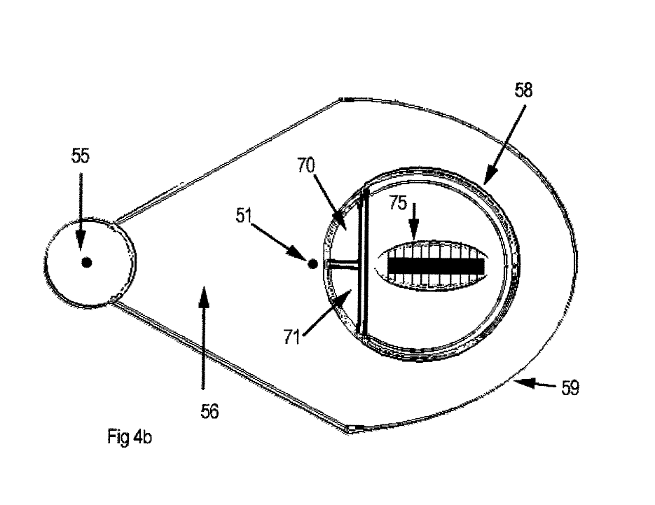

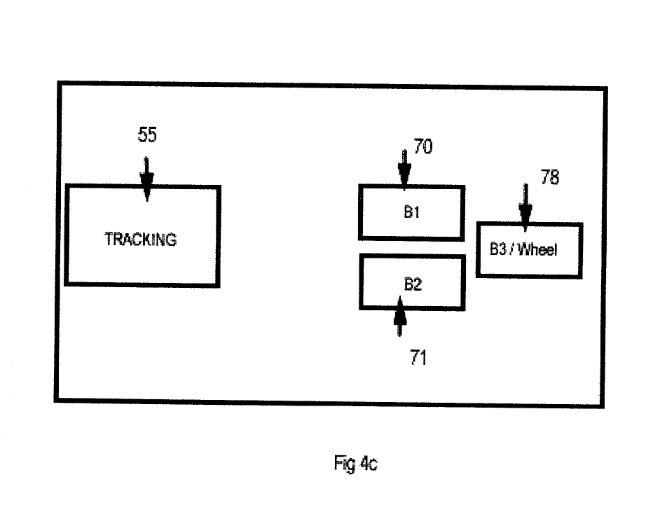

FIG. 3 is a perspective view of a new and improved pointer control 50 in accordance with this invention. In FIG. 3 the optical sensor 55 is located at the extreme front end of the unit. FIG. 4A shows that optical sensor 55 in side view.

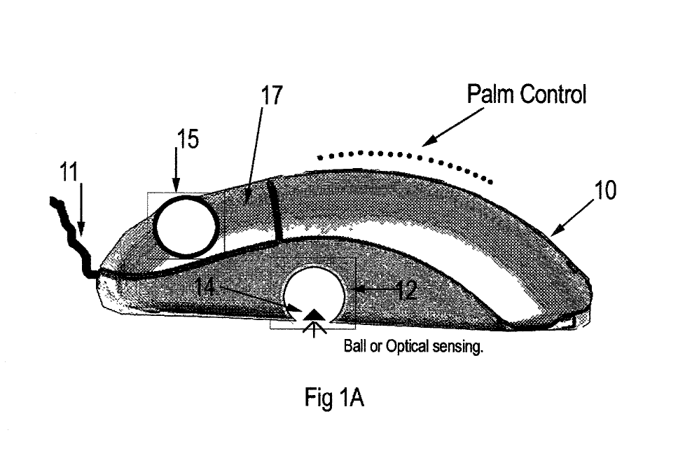

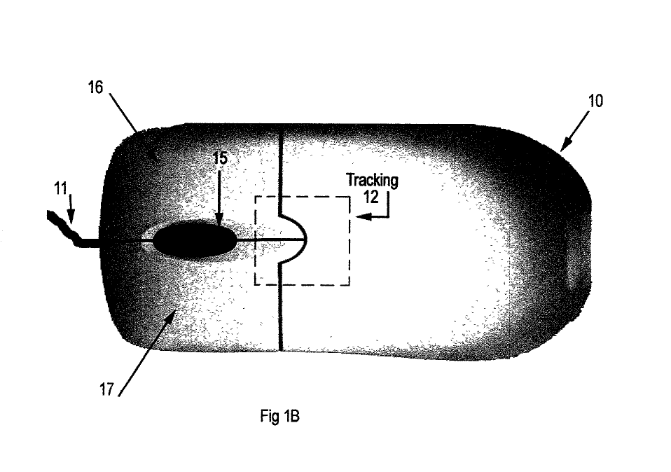

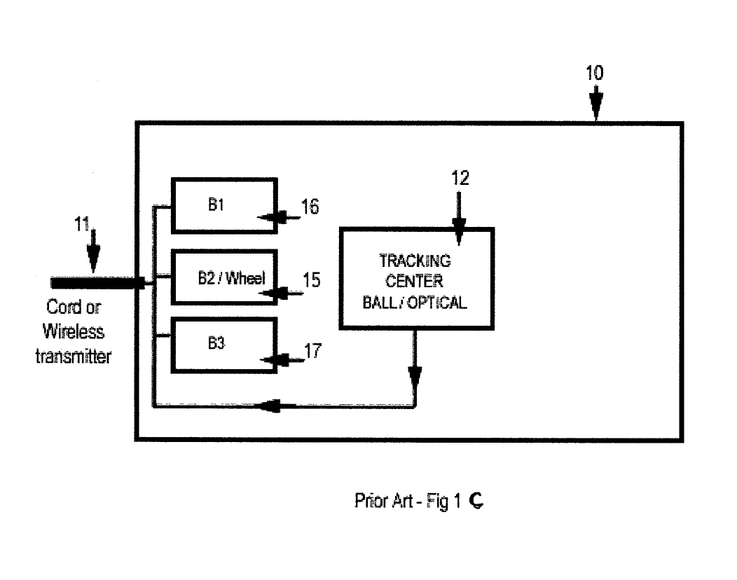

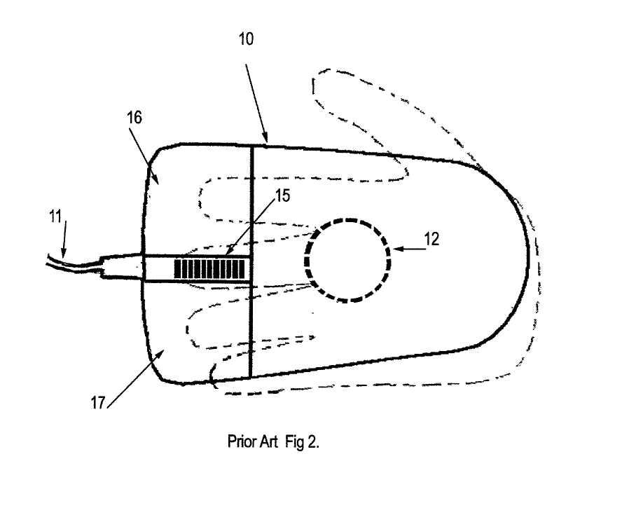

FIGS. 4B and 4C should be contrasted with the similar figures of the prior art of FIGS. 1B and 1C in order to appreciate the relocation of parts as achieved by this my invention. Primarily, as shown in FIG. 4C, the tracking for the novel control of this invention is at the forward end, while the switching and control movement is done by finger control at the rear end of the unit 50 Optical sensor 55 may be of any known types such as the type marketed by Agilent and as fully described in a series of technical papers available on the Internet under the Agilent menu for Optical Devices. The titles of such Agilent papers include: Solid-State Optical Mouse Sensor with PS/2 and Quadrature Outputs, Solid State Optical Mouse LED Assembly Clip, Radiometrically Tested AlInGaP II LED Lamps for Sensor-Based Applications, Solid-State Optical Mouse Sensor and Solid-State Optical Mouse Lens. These technical papers fully describe the operation of such a sensor 55 and need not be repeated here. Such papers, by this reference, are incorporated herein as though set forth in full.

Briefly summarized, such an optical sensor 55 is a tracking device which measures changes in position by optically acquiring sequential surface images (by a camera, light and lens) and mathematically determining the direction and magnitude of mouse movement. In operation, the sensor at high rates such as about 2000 scans per second takes one picture after another in magnified form of the surface below a lighted lens.

Digital scan and comparison operations of each picture with its forerunner reveals the direction and magnitude of the movement of the mouse. This tracking information is converted into signals for transmission to the computer via a cord for pointer control on the screen of a computer console display.

In accordance with my invention, control 50 may be of a molded one piece construction from material such as plastic or a similar material with inner cavities as necessary to house the optical sensor, micro switches and the like. An optical sensor 55 is housed in a cavity which is located at the extreme forward end of the control 50 about 1 and ¾ inches in front of the center of movement 51 for the control.

Control 50 of my invention consists of a one-piece base having a pointed, or triangular-shaped front section 56 that continues on into a rear section 57. The rear end section has two hemisperically shaped pieces of two separate diameters, with the smaller diameter primarily being for use by the smaller hands of children.

The front end pointed section 56 has at its base a substantially semicircular trailing end 57 for the control substantially as shown in FIGS. 3 and 4. The rear section 57 has two levels, namely a lower level 60 and an upper level 65 as best shown, perhaps, by the side view of FIG. 4A. Affixed to the outer periphery of the curved section 57 at both levels are gripping surfaces 58 and 59. These gripping surfaces may be of a soft rubber or felt or similar material that is embedded within, or adhered to, the outer periphery of the rear section 57 in order to enhance the manual fingertip movements of my pointer control invention.

The upper level is a disk-shaped smaller diameter dial with raked flat front buttons 70 and 71. Housed in the center of the upper disk 75 is a depressible wheel 78. Within the control (not shown) are micro switches that respond to depression of the wheel 78 or buttons 70, 71 in a well known fashion to form switching signals that are sent to the computer by control 50.

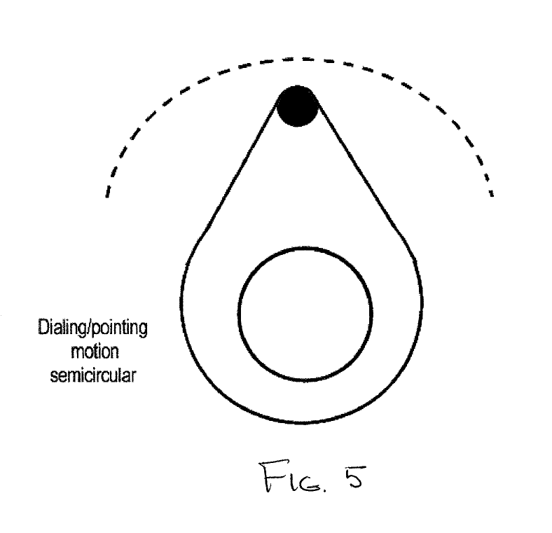

FIG. 5 depicts a top view of the control 50 of the invention as it rotates around the center of movement 51 for the control. Rotation by the user's fingertips will achieve right-to-left control without any hand or arm movement, thus reducing the chances of carpel tunnel syndrome and improving markedly the speed and accuracy of pointer control. The lower and larger diameter dial will achieve an arc of movement of about 120 degrees. The smaller inside disk will achieve an arc control of about 140 to 180 degrees.

Providing two different diameters for the control at the rear end section has the added advantage that children will tend to use the smaller disk, while adults with larger finger span will find the larger diameter of the base to their liking. Although the arc appears large on the drawing of FIG. 5, it has been confirmed on the screen that the left to right movement achieved by rotation as there shown is essentially flat. Such left to right movement—particularly with the smaller inner dial—is very rapid and thus is highly desirable for computer games where speed and accuracy is essential.

While my invention has been described with reference to a particular example of preferred embodiments, it is my intention to cover all modifications and equivalents within the scope of the following claims. It is therefore requested that the following claims, which define my invention, be given a liberal interpretation which is within the spirit and scope of my contribution to this art.

What is claimed is:

1. A manually moveable control unit for moving a pointer on a console display screen, said control unit comprising;
a manually moveable substantially flat base having a forward and a rear end section;
a substantially semicircular-shaped rear end of said control unit adapted for fingertip control of said unit by a user; and
an optical movement tracking sensor mounted in the forward end of said unit for generating tracking signals representative of movements imparted to said unit by a user's fingertips.

2. The control unit of claim 1 and further having a center of movement between said forward and rear end, said unit further comprising:
switching means positioned behind said center of movement and toward the rear end of said control unit.

3. The control unit of claim 1 and further comprising:
a soft pliable gripping surface housed in said semicircular end of said control unit.

4. The control unit of claim 1 and further comprising:
said flat base being of one piece construction having a forward substantially triangular shape and a base joined at a diameter for said semicircular rear end of said unit.

5. The control unit of claim 1 and further comprising:
said unit being characterized in that the user free of arm movement imparts fingertip movement to the unit.

6. The control unit of claim 1 and further comprising:
rotation of said unit about the center of movement of said base sweeps said forward-mounted tracking sensor in a flat arc for left to right pointer control signals.

7. The control unit of claim 2 and further comprising:
a disk-like fingertip dial extending upward from the rear end of said unit and having a rearward section thereof in a substantially semicircular shape adapted for fingertip control.

8. The control unit of claim 7 wherein said disk-like dial has a slanted front, and said control unit further comprises:
left and right depressible buttons formed in said slanted front for said switching means.

9. A control unit of claim 7 and further comprising;
a depressible wheel mounted in the center of said disk-like dial as an additional switch within said switching means.

10. A method of fashioning a manually moveable control unit that is in signal communication with a computer for delivering thereto signals representative of movements of said unit, which signals, in turn, move a pointer on a console display screen, said method comprising the steps of;
providing a substantially flat base with a forward end, a middle center of movement and a rear end section;
shaping the rear end section substantially as a semicircular disk;
adapting said semicircular section with gripping surfaces for fingertip control of said unit;
mounting an optical movement tracking sensor in the forward end of said unit; and
generating tracking signals representative of movements imparted to said unit by a user's fingertips.

11. The method of fashioning a manually moveable control unit in accordance with claim 10 and further comprising the steps of:
positioning switching means behind the center of movement and toward the rear end of said control unit.

12. The method of fashioning a manually moveable control unit in accordance with claim 10 and further comprising the steps of:
housing a soft pliable gripping surface in said semicircular end of said control unit.

13. The method of fashioning a manually moveable control unit in accordance with claim 10 and further comprising the steps of:
forming said flat base of one piece construction;
placing in said one piece base a forward end of substantially a triangular shape;
joining a base of said triangular shape with a diameter for said semicircular rear end in order to complete said base.

14. The method of fashioning a manually moveable control unit in accordance with claim 10 and further comprising the steps wherein a user:
free of arm movement, imparts movement to said base by the fingertips.

15. The method of fashioning a manually moveable control unit in accordance with claim 10 and further comprising the steps of:
rotating said unit about the center of movement of said base;
sweeping said forward mounted tracking sensor in a flat arc for forming left to right pointer control signals.

16. The method of fashioning a manually moveable control unit in accordance with claim 10 and further comprising the steps of:
extending upward from the rear end of said unit a disk-like fingertip dial having a slanted front and a rearward section thereof shaped substantially in a semicircularpherical shape adapted for fingertip control.

17. The method of fashioning a manually moveable control unit in accordance with claim 10 and further comprising the steps of:
equipping said switching means with left and right depressible buttons that are formed in said slanted front.

18. The method of fashioning a manually moveable control unit in accordance with claim 10 and further comprising the steps of:
mounting a depressible wheel at about the center of said disk-like dial as an additional switch when said wheel is depressed.

19. A manually moveable control unit for moving a pointer on a console display screen, said control unit comprising;
a manually moveable substantially flat base having a forward and a rear end section;
said forward end being of substantially triangular shape joined at a first diameter with a semicircular curved rear end;
a disk-like fingertip dial of a second smaller diameter having a common center with said first semicircle and extending upward from the rear end of said unit with a rearward section thereof in substantially semicircular shape; and
fingertip holding means including soft pliable gripping surfaces housed in each of said semicircular ends of said control unit.

20. A manually moveable control unit having a forward and a rear end section and a center of movement with a vertical axis therethrough for moving a pointer in x and y directions on a console display screen, said control unit comprising;
an optical movement tracking sensor mounted in the forward end of said unit for generating tracking signals representative of movements imparted to said unit by a user's fingertips; and
a substantially semicircular-shaped rear end of said control unit adapted for fingertip rotation of said unit about said vertical axis for right-left control of said pointer, and back and forth movement of said control for up-down control of said pointer.
